(19) United States
(12) Patent Application Publication
(10) Pub. No.: US 2024/0343564 A1
(43) Pub. Date: Oct. 17, 2024

(54) METHOD AND DEVICE FOR OBTAINING HIGH-PURITY HYDROGEN FROM METHANOL OR AMMONIA FOR OPERATING FUEL CELLS

(71) Applicant: BASF SE, Ludwigshafen am Rhein (DE)

(72) Inventors: Carsten HENSCHEL, Ludwigshafen (DE); Otto MACHHAMMER, Mannheim (DE); Andreas FUESSL, Ludwigshafen (DE)

(21) Appl. No.: 18/683,136

(22) PCT Filed: Aug. 3, 2022
(86) PCT No.: PCT/EP2022/071783

§ 371 Date: Feb. 12, 2024

(30) Foreign Application Priority Data
Aug. 13, 2021 (EP) 21191316.5

(51) Int. Cl. C01B 3/32; C01B 3/50; H01M 8/0606

(52) U.S. Cl. CPC C01B 3/323; C01B 3/505; C01B 2203/0205; C01B 2203/0283; C01B 2203/0405; C01B 2203/066; C01B 2203/0827; C01B 2203/1223; C01B 2203/1294; H01M 8/0606

(57) ABSTRACT

A process for obtaining hydrogen from methanol or ammonia, for fuel cell operation, for example, wherein methanol or ammonia is subjected to evaporation in a first step and in a second step to reforming to give a hydrogen-containing gas mixture, in a third step hydrogen is removed from this gas mixture in a membrane process at a temperature of 300 to 600° C. and in a fourth step the gaseous retentate from the membrane process is burned with ambient air, wherein the second step is a process step upstream of and separate from the third step and the combustion gases are routed via at least two different heat exchangers to provide (i) first the reaction heat for reforming the methanol or ammonia and (ii) then the evaporation heat for evaporating the reformer feed, wherein the permeate from the membrane process preheats the ambient air for the burner in a heat exchanger

The subject of the present invention is a process for obtaining hydrogen from methanol or ammonia, for fuel cell operation, for example, which is characterized in that methanol or ammonia is subjected to evaporation in a first step and in a second step to reforming to give a hydrogen-containing gas mixture, in a third step hydrogen is removed from this gas mixture in a membrane process at a temperature of 300 to 600° C. and in a fourth step the gaseous retentate from the membrane process is burned with ambient air, wherein the second step is a process step upstream of and separate from the third step and the combustion gases are routed via at least two different heat exchangers to provide, in the flow direction of the combustion gases, (i) first the reaction heat for reforming the methanol or ammonia and (ii) then the evaporation heat for evaporating the reformer feed, wherein the permeate from the membrane process preheats the ambient air for the burner in a heat exchanger, the temperature differences between (a) the outgoing permeate and the incoming ambient air and (b) the outgoing combustion gas and the incoming methanol or ammonia each being between 1 and 200° C., and wherein during the third process step there is a further temperature increase of not more than 0 to 100° C.

A further subject of the present invention is an apparatus for obtaining high-purity hydrogen from methanol or from ammonia, for example fuel cell operation, for a hydrogen filling station or for the decentralized supply of small industrial applications.

Hydrogen offers the desired prerequisites to become the key factor for the energy supply of the future. The transport sector in particular is faced with the major challenge of becoming more climate-friendly. In Germany, transport is responsible for almost 20 percent of total CO2 emissions, with a good half of this coming from private transport.

The introduction of electromobility, which includes battery-electric and fuel cell-electric vehicles, is allowing the transport sector to reduce its dependence on petroleum-based fuels. In the best case, the hydrogen or power needed to operate the vehicles is produced from regenerative energy sources. In the transport sector, hydrogen is a new fuel that produces no pollutants locally when used with fuel cell technology.

In order to be able to use hydrogen in fuel cell applications, the hydrogen must be present in a very high quality, since impurities have effects on catalysts and membranes.

At present, hydrogen is produced mainly centrally in comparatively large steam methane reforming (SMR) production units. The hydrogen is subsequently highly compressed (to 350 bar) and in rare cases also liquefied, for it to be brought by means of corresponding transport vehicles to the location at which it is needed, such as a hydrogen filling station, for example. The transport of hydrogen by vehicle, however, is uneconomic and unenvironmental, since larger hydrogen filling stations would require daily truck deliveries.

In parallel with vehicle transportation, there are a certain number of pipelines purely for hydrogen. In order to enable extensive supplying of hydrogen to filling stations, however, it would be necessary to construct a dense, dedicated network of hydrogen pipelines on the analogy of the natural gas network. Pipeline networks of this kind, however, have very high infrastructure costs and, moreover, require costly and complicated approval processes, making their realization in the near future seem unlikely.

Consideration is also being given to the decentralized production of hydrogen in relatively small production units, by means of electrolysis or steam methane reforming (SMR), for example, thereby shortening the transport route or eliminating it altogether.

The power requirements of water electrolysis are very high and must be provided, owing to the poor storability of H2 at filling stations, by the available network power on a demand-controlled basis. Since, however, in Germany, for example, the network power will possess a large carbon footprint for a further decade, a vehicle operated with electrolysis H2 generated using network power will generate more CO2 over the next decade, viewed overall, than a vehicle with a diesel or gasoline engine.

Methanol (MeOH) is a basic chemical, produced on the industrial scale, and is an excellent energy source in view of its high energy density of 19.9 MJ/kg. Unlike hydrogen, methanol can be inexpensively transported (O. Machhammer, “Regenerative power from Germany or e-fuels from Chile: which should be the foundation of future mobility?” [in German], Chemie Ingenieur Technik, No. 4, 2021). As far as transport is concerned, the existing crude oil transport infrastructure can be employed.

Furthermore, automobiles can be filled up with methanol, allowing the existing filling station network to be utilized without major alterations.

As a basic chemical, methanol is primarily still utilized at present for further processing, to formaldehyde, acetic acid, methyl chloride, methyl methacrylate and methylamines, for example. With these processes, the energy balance plays a minor part—the added value from the downstream products is essential.

Ammonia (NH3) is a basic chemical which is produced on the industrial scale, for the production of fertilizer, for example. Ammonia is a good energy source; at 18.6 MJ/kg, it has almost the same energy density per unit mass as methanol (MeOH) with 19.9 MJ/kg. Ammonia possesses a boiling point of −33° C. and can be transported in 10 bar low-pressure containers at ambient temperature. A key feature of energy sources of the future will be their small carbon footprint. In the case of NH3, in addition to H2 with a small carbon footprint, nitrogen (N2) is also required, and at around 80% is in highly concentrated form in the atmosphere and accordingly can be obtained easily and cheaply via an air separation plant.

Countries with too little sunshine and/or wind, and/or without sufficient land, will be unable themselves to cover their demand for regeneratively produced hydrogen.

Today already, therefore, there are efforts being made to produce this demand for regenerative energy in future in countries possessing very favorable conditions in this respect, such as the MENA (Middle East North Africa) states, for example. One example of such a project is currently the world's largest green hydrogen/ammonia project, NEOM HELIOS, in Saudi Arabia.

Given the presently primary utilization of ammonia as a compound, for fertilizer, for example, the energy balance plays a minor part. Essential in this context is the effect of the fertilizer.

Known methods for the separation of N2 and H2 are distillation methods, sorption methods or membrane methods. Membrane methods are preferred, since they are unaffected by the low boiling temperatures of the two components for separation.

The hydrogen can be provided at a filling station for the filling of fuel cell (FC) vehicles. For this purpose, for intermediate storage, the hydrogen is compressed to the required pressure of 950 bar and on filling is cooled to the required temperature of −40° C.

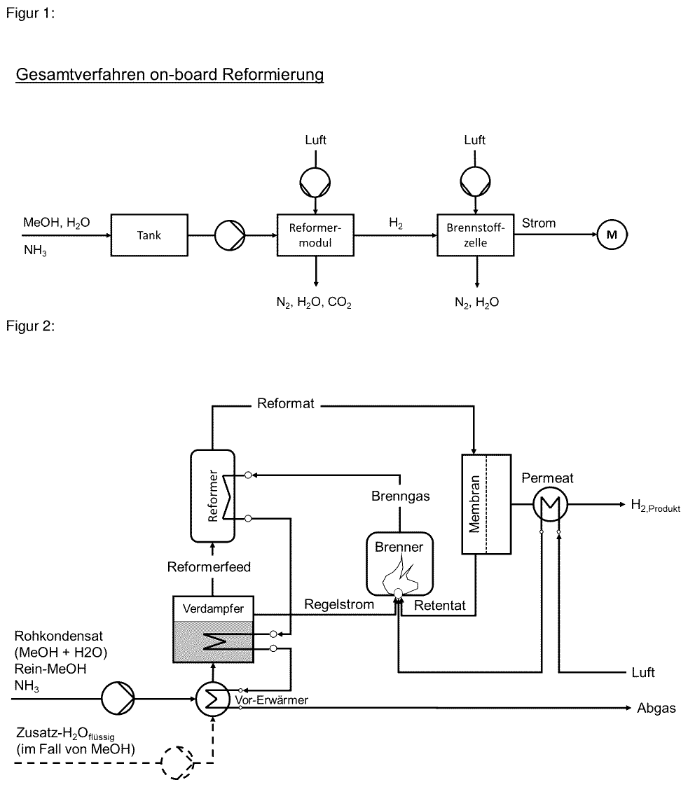

Advantageously, however, the hydrogen needed for the fuel cell (FC) can be obtained advantageously in the motor vehicle (MV) via on-board reforming, in accordance with FIG. 1, from the methanol or the ammonia. The H2 liberated in this process can be subsequently converted to electricity in a fuel cell for the operation of the electric vehicle.

As a result of the use of methanol or ammonia, there is no need first to have to acquire a complicated and very expensive H2 transport and filling station infrastructure, before fuel cell automobiles can experience widespread success.

With methanol or ammonia as energy source, conversely, a leading part is played by the energy balance of the overall process. The overall process, from the reforming of the methanol or ammonia through the liberation of the H2, ought advantageously to show low energy losses, in order to retain as much as possible of the energy originally employed.

The operation of fuel cells (FC) requires hydrogen of very high purity (>99.99%). The production of hydrogen on board with very high purity from methanol or ammonia necessitates a plurality of process steps: the evaporation and splitting of methanol or ammonia, and the removal of the high-purity hydrogen from the resultant gas mixture. The thermal energy that is needed for the evaporation and the cleaving must either be supplied from outside or else provided by combustion of a part of the methanol used, of the ammonia used, or of a part of the reforming products.

The state of the art for on-board fuel cell operation is focused mainly at the optimized conversion in the reforming and on an optimized removal of hydrogen. The overall energy efficiency has to date played a minor part.

### Methanol:

U.S. Pat. No. 5,741,474 discloses a process for obtaining hydrogen from methanol in a membrane reactor, where the methanol is evaporated in a first step and in a second step is reformed into a hydrogen-containing gas mixture in a membrane reactor, the reforming chamber, and at the same time the hydrogen formed is removed from the gas mixture by means of a membrane. Methanol and the gaseous retentate from the membrane process undergo combustion with air in a burner, thereby providing the necessary heat for the evaporation and reforming via heat exchange. U.S. Pat. No. 5,741,474 therefore combines the reforming reaction and the hydrogen removal in a single process step and in a single chamber, and so the process conditions in these processes are the same. The reforming temperature therefore corresponds to the temperature of hydrogen removal. Moreover, U.S. Pat. No. 5,741,474 discloses neither sequential heat exchange of the combustion gases nor preheating of the ambient air for the burner by means of the permeate.

WO 2004/2616 discloses a process which consists of a catalytic methanol reforming at 300 to 500° C. with a subsequent removal of H2 via pressure swing adsorption (PSA) or using palladium alloy membranes. The energy for the reforming and removal of hydrogen is provided by an internal or external energy source; the variant of using the retentate from the H2 removal as a fuel is not disclosed.

WO 2003/86964 describes a reforming apparatus in which the methanol reforming and the H2 removal from the reformate are carried out by means of a palladium-based membrane or a PSA. Temperatures disclosed are 200 to 700° C. for the reforming and 200 to 400° C. for the methanol reforming. The retentate from the H2 removal is burned as an energy source. No information is disclosed regarding the connection of the heat exchangers needed. Nor is there any description of preliminary heating of the burner air or of the methanol.

WO 2003/27006 describes a total on-board system composed of methanol evaporation and reforming, H2 removal, and fuel cell. Reforming and H2 removal take place simultaneously in a membrane reactor, the membrane reactor being operated at 100° C. In the view of the authors, the Pd membrane reactor suffers embrittlement at relatively high H2 partial pressures (>5 bar) and temperatures (>200° C.). The energy source described is the catalytic combustion of the retentate from H2 removal and the offgas from the fuel cell. No information is disclosed regarding the connection of the heat exchangers needed. Nor is there any description of preliminary heating of the burner air or of the methanol.

Emonts et al. (B. Emonts, J. B. Hansen, H. Schmidt, T. Grube, B. Höhlein, R. Peters and A. Tschauder, “Fuel cell drive system with hydrogen generation in test”, Journal of Power Sources, No. 86, pp. 228-236, 2000), for the testing of the regulation characteristics, describe an on-board fuel cell system which consists of a compact methanol reformer (CMR) and a polymer electrolyte membrane fuel cell (PEMFC). The CMR includes a methanol reforming, a removal of hydrogen using a palladium membrane, and a catalytic burner which burns the retentate and provides the resultant heat to the reforming. A second catalytic burner, operated with methanol, supplies the evaporation unit. In standard operation, the combustion gas leaves the system at a temperature of 180° C. The reforming and H2 removal are carried out at a temperature of 260 to 280° C.

Y.-M. Lin et al. (Y.-M. Lin and M.-H. Rei, “Study on the hydrogen production from methanol steam reforming in supported palladium membrane reactor”, Catalysis Today, No. 67, pp. 77-84, 2001; Y.-M. Lin, G.-L. Lee and M.-H. Rei, “An integrated purification and production of hydrogen with a palladium membrane-catalytic reactor”, Catalysis Today, No. 44, pp. 343-349, 1998) describe preferred temperature ranges of 300 and 400° C. for the methanol reforming in a membrane reactor with palladium membranes on stainless steel supports, which is operated with electrical power. It is disclosed that signs of embrittlement appear in the palladium membrane below 300° C., and intermetallic diffusion between the palladium film and the stainless steel support occurs above 400° C., causing the H2 permeance to drop.

### Ammonia:

U.S. Pat. No. 7,811,529 discloses a process for obtaining hydrogen from ammonia in a membrane reactor, where in a first step the ammonia is evaporated and in a second step it is reformed in a hydrogen membrane reactor, with the resultant hydrogen being removed at the same time by means of a membrane. Ammonia and the gaseous retentate from the membrane process are burned in a burner with air, so providing the necessary heat for the evaporation and reforming via heat exchange. U.S. Pat. No. 7,811,529 therefore combines the reaction of reforming and the removal of the hydrogen in the hydrogen membrane reactor, and consequently the conditions of these processes are the same.

GB 1,079,660 discloses a total process which consists of catalytic NH3 cleavage and subsequent H2 removal over Pd alloy membranes. A preferred temperature range of 650 and 930° C. is described for the NH3 cleavage; preferred pressure ranges are not disclosed. The energy for the NH3 evaporation and cleavage is generated electrically. A disadvantage when using electrical energy for the NH3 evaporation and cleavage is that this current is generated most favorably in the downstream FC with an efficiency of not more than 70%. Consequently, not only the NH3 evaporation and cleavage but also the H2 removal and the expensive FC must be made larger than in the case of the direct utilization of the retentate combustion energy for the NH3 evaporation and cleavage; because of the loss of efficiency, more NH3 is consumed as well.

WO 2018/235059 A1 discloses a membrane reactor and a process for on-board generation of power via NH3 cleavage using a low-temperature plasma and simultaneous H2 removal using Pd—Ag membranes. On account of the permanent H2 removal, a virtually complete NH3 conversion is achieved even at low temperatures of 200 to 500° C. and at relatively high pressures of 8 to 10 bar. Again, the cleavage energy is supplied electrically.

WO 02/071451 A2 discloses an H2-generating apparatus for on-board applications. At its core is a compact heat exchanger reactor configured with numerous channels. While, in one half of the channels, NH3 is cleaved into N2 and H2 at 550 to 650° C. over ruthenium-nickel catalysts, in the other half of the channels a fuel is burnt catalytically in order to provide the heat for the NH3 cleavage. The reformate from the NH3 cleavage, which consists primarily of N2 and H2, is converted into power in an FC. To protect the fuel cell from unreacted NH3, the process gas is passed beforehand over an adsorber bed. The preferably acidic adsorber material is not regenerated on board, but is instead replaced. The proposal is that the cleavage energy be provided by catalytic combustion of NH3 or, preferably, by catalytic combustion of an accompanying butane cargo. To start the process, the apparatus is to be brought to reaction temperature using power from a battery. The process disclosed is suitable for generating electrical power, but not for generating high-purity hydrogen for—for example—the filling station scenario, since there is no separation of N2 and H2. The efficiency of a fuel cell is lower if it is fed with a mixture of N2 and H2 rather than with pure H2.

L. Lin et al. (L. Lin, Y. Tian, W. Su, Y. Luo, C. Chen and L. Jiang, “Techno-economic analysis and comprehensive optimization of an on-site hydrogen refuelling station system using ammonia: hybrid hydrogen purification with both high H2 purity and high recovery”, Sustainable Energy Fuels, vol. 4, pp. 3006-3017, 2020) describe a multistage process for the production of high-purity H2 from NH3 for an H2 filling station. The results are based on simulations. The process considered comprises the stages of catalytic NH3 cleavage at 500° C., removal of the unreacted NH3 in a PSA (pressure swing adsorption), separation of the N2/H2 gas stream through a combination of PSA and membrane methods, and the compression of the product stream, having a purity of 99.97%, to a pressure of 900 bar for the filling station fuel dispenser. 15.5% of the gas stream from NH3 cleavage are burned to cover the required reaction enthalpy. The fact that the reaction enthalpy for the NH3 cleavage is provided by burning of the reformate (N2, H2 and unreacted NH3) and not by burning of the retentate dictates that as little H2 as possible should be lost via the retentate. As will be shown, this reduces the driving partial pressure difference for the N2/H2 separation and leads overall to low energy efficiencies.

Lamb et al. (K. E. Lamb, D. M. Viano, M. J. Langley, S. S. Hla and M. D. Dolan, “High-Purity H2 Production from NH3 via a Ruthenium-Based Decomposition Catalyst and Vanadium-Based Membrane”, Industrial & Engineering Chemistry Research, vol. 57, pp. 7811-7816, 2018) describe a process for the production of high-purity hydrogen from NH3. NH3 cleavage was carried out at 5 bar and 450° C., and the membrane separation at 340° C. On the permeate side, a reduced pressure of 0.1 bar was established. For a stand-alone plant, the authors propose burning the hydrogen remaining in the retentate stream in order to use it to provide the energy for the NH3 cleavage. The authors recommend obtaining 75% of the hydrogen from the NH3 cleavage in the membrane stage as a product, and burning the remaining 25% for the NH3 cleavage. No details are disclosed regarding the configuration of energy transfer for the endothermic reforming and the evaporation.

A disadvantage of the use of membrane reactors is that the reforming and H2 removal must necessarily take place at the same temperature level. With membrane reactors, therefore, it is not possible to operate both the reforming process and the removal process in their respective optimal ranges. The interaction is always a process engineering compromise: a lower temperature in the membrane reactor is beneficial to the degree of energy utilization, whereas a higher temperature is beneficial to the removal of hydrogen. One of the consequences of the continuous removal of H2 during the reforming process is the accumulation of CO2 in the reaction mixture. Another is that the necessary heat of reaction must be supplied by way of the heated reactor walls. A high CO2 concentration and hot reactor walls lead to instances of coke deposition. There is therefore an increased risk of blockage of the membrane. To prevent this, water must be introduced additionally into the reaction, causing the energetic efficiency to drop.

In academic terms, membrane reactors are extremely interesting, owing to the process engineering coupling of reaction and H2 removal; because of the disadvantages identified above, however, they have to date had virtually no practical significance.

However, looking at the overall process chain made up of evaporation, reforming and H2 removal, from the standpoint of the highest energy efficiency and the lowest capital costs, it turns out to be the case, surprisingly, that a separation of reforming and H2 removal is more conducive to very low H2 production costs.

The desire is therefore for a process for obtaining hydrogen with high purity from methanol or ammonia for fuel cell operation, a hydrogen filling station or the decentralized supply of small industrial applications, the process producing hydrogen with minimal energetic losses. Low complexity of apparatus and therefore low costs are also advantageous. Another advantageous feature is a low level of material requirement for the membrane areas. For the energetic efficiency, furthermore, it is advantageous if the temperature difference between the starting material, methanol or ammonia, and the offgas, and also between the hydrogen product stream obtained and the burner air required, is as low as possible.

The subject of the present invention is a process for obtaining hydrogen from methanol or ammonia, advantageously for fuel cell operation, which is characterized in that methanol or ammonia is subjected to evaporation in a first step and in a second step to reforming to give a hydrogen-containing gas mixture, in a third step hydrogen is removed from this gas mixture in a membrane process at a temperature of 300 to 600° C. and in a fourth step the gaseous retentate from the membrane process is burned with ambient air, wherein the second step is a process step upstream of and separate from the third step and the combustion gases are routed via at least two different heat exchangers to provide, in the flow direction of the combustion gases, (i) first the reaction heat for reforming the methanol or ammonia and (ii) then the evaporation heat for evaporating the reformer feed, wherein the permeate from the membrane process preheats the ambient air for the burner in a heat exchanger, the temperature differences between (a) the outgoing permeate and the incoming ambient air and (b) the outgoing combustion gas and the incoming methanol or ammonia each being between 1 and 200° C., and wherein during the third process step there is a maximum temperature increase of 0 to 100° C.

FIG. 2 shows the essential steps of the invention.

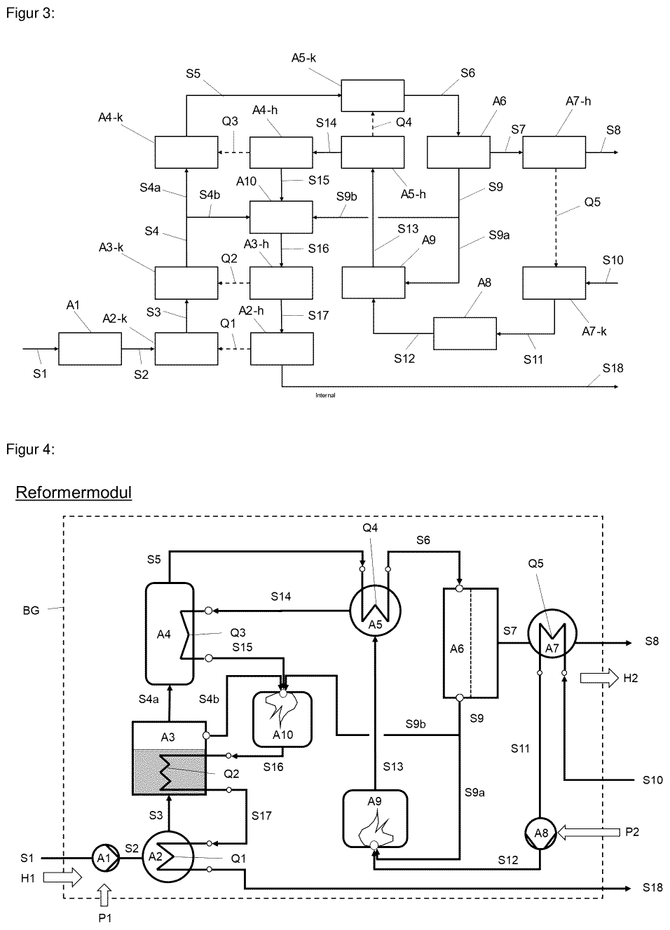

FIG. 3 shows the process-technical variants schematically.

### First Step

### Methanol:

An evaporator is supplied with methanol and optionally water. The fraction of water is advantageously 0 to 75 mol % relative to the methanol-water mixture, preferably 10 to 70 mol %, more preferably 25 to 65 mol %, more particularly 40 to 60 mol %, and very preferably the molar ratio of methanol to water is 1:1.

The methanol or the methanol-water mixture is evaporated to give the gaseous reformer feed in an evaporator at pressures between 4 to 60 bar, which subject to adjustment for pressure loss are the same throughout the process. The pressure in the evaporator is advantageously 5 and 30 bar, more particularly between 10 and 20 bar. For the skilled person, the pressure details reveal the temperatures which are required for evaporation.

### Ammonia:

Alternatively, liquid ammonia is withdrawn from a tank, advantageously at −35 to 50° C. and 1 to 20 bar, and is brought if required to higher pressures by means of a pump. The liquid ammonia advantageously becomes the gaseous reformer feed in the evaporator at pressures between 2 and 60 bar, which are the same, subject to adjustment for pressure losses, throughout the process. The pressure in the evaporator is advantageously between 4 and 40 bar, more preferably between 6 and 30 bar, more particularly between 10 and 20 bar. For the skilled person, the pressure details reveal the temperatures which are required for evaporation, advantageously −20° C. to 100° C.

As in the case of the methanol, the vaporous NH3 stream is split advantageously into a reformer feed, which is supplied to the reformer, and a regulating flow, which is admixed to the retentate flow as and when required, such as during start-up and for regulating the process, for example.

### Second Step

Methanol:

The reformer feed, i.e., the gaseous methanol or methanol-water mixture, is subsequently subjected to catalytic reforming at temperatures between 10° and 400° C. to give a likewise gaseous reformate. The temperature of the methanol reforming is preferably 180 and 350° C., more particularly between 240° C. and 300° C. Low methanol reforming temperatures increase the H2 yield at the expense of the CO fraction, on the basis of the WGS equilibrium.

The methanol reformate contains H2, CO, CO2, H2O, and unreacted MeOH or DME. The composition of the gaseous methanol reformate consists preferably of 55 to 75 mol % H2, 1 to 8 mol % CO, 10 to 25 mol % CO2, 2 to 10 mol % H2O, and 0.1 to 20 mol % MeOH and/or DME, more preferably of 60 to 70 mol % H2, 1 to 5 mol % CO, 15 to 25 mol % CO2, 2 to 9 mol % H2O, and 1 to 10 mol % MeOH and/or DME.

The conversion in the methanol reforming is advantageously 70% to 99%, preferably 80% to 95%, more preferably 85% to 90%.

In the reforming of the methanol there is the reversal of the CO2 hydrogenation

$$3 H2 + CO2 = CH3OH + H2O$$

$${DH}_{R}^{0} = - 49 kJ / mol CH3OH$$

in accordance with the following overall reaction equation

$$CH3OH = 2 H 2 + CO$$

$${DH}_{R}^{0} = + 90 kJ / mol CH3OH$$

In accordance with the invention, the methanol to be used may also include fractions of dimethyl ether (C2H6O), typically 1 to 5 wt %. In the presence of H2O, dimethyl ether undergoes simultaneous reforming to give methanol.

Water reacts with CO in accordance with the following overall reaction equation:

$$H2O + CO = H 2 + CO 2$$

$${DH}_{R}^{0} = - 41 kJ / mol CO$$

This exothermic reaction is called the water-gas shift (WGS) reaction. As a result of the water fraction in the methanol, it is possible advantageously to increase the H2 yield and to reduce the additional energy requirement for the overall process made up of reforming and WGS.

The maximum CO2 formed in the overall process via WGS reaction and/or combustion of methanol and/or CO corresponds to the CO2 used in the preparation of methanol from CO2 and H2. The overall process, accordingly, is CO2-neutral.

During the second step, the reforming, advantageously no hydrogen stream is drawn off. Advantageously, therefore, the second step is a separate step upstream of and independent from the third step. Advantageously, furthermore, the second step is separate from and downstream of the first step. The advantageous successive process steps are represented in FIG. 4. It may be advantageous, for example, to heat the reformate further in a heat exchanger (reformate heater), since it is consequently possible to reduce the area of the cost-intensive Pd membrane in the subsequent membrane module.

Catalysts for the reforming of methanol are described in the prior art (see, e.g., F. Gallucci et al., “Hydrogen Recovery from Methanol Steam Reforming in a Dense Membrane Reactor: Simulation Study”, Ind. End. Chem. Res. 2004, 43, 2420-2432) and A. Basile et al., “A dense Pd/g membrane reactor for methanol steam reforming: Experimental study”, Catalysis Today, 2005, 104, 244-250). For example, active catalyst components used are CuO/ZnO/Al2O3 mixtures, advantageously in the composition of 38 wt % CuO, 41 wt % ZnO and 21 wt % Al2O3, or mixtures in the composition of 31 wt % CuO, 60 wt % ZnO and 9 wt % Al2O3.

The methanol reformate is optionally then heated to the preferred temperature of 300 to 700° C., preferably 350 to 600° C., more particularly 400 to 500° C., for the H2 removal.

### Ammonia:

In analogy to the methanol case, the NH3 vapor stream is advantageously supplied to a reformer, where it is split into H2 and N2. The energy required for the splitting is covered advantageously by a heat flow. Ammonia reforming takes place advantageously at temperatures of 100 and 700° C., preferably 200 to 600° C., more particularly between 300° C. and 500° C. Ammonia reforming takes place advantageously at a pressure of 2 to 60 bar, preferably 6 to 30 bar, more particularly 10 and 20 bar.

The gaseous ammonia reformate advantageously contains H2, N2 and unreacted NH3 in the following preferred composition: 60 to 75 vol % H2, 20 to 25 vol % N2, 0 to 20 vol % NH3.

The conversion in the ammonia reforming is advantageously 70% to 99%, preferably 80% to 95%, more preferably 85% to 90%.

During the second step, the reforming, advantageously no hydrogen stream is drawn off. Advantageously, therefore, the second step is a separate step upstream of and independent from the third step. Advantageously, furthermore, the second step is separate from and downstream of the first step.

Catalysts for the reforming of ammonia are described in the prior art (see A. Di Carlo et al., “Ammonia decomposition over commercial Ru/Al2O3catalyst: An experimental evaluation at different operative pressures and temperatures”, International Journal of Hydrogen Energy, 39 (2014), pp. 808-814). Ruthenium is used for example as the active catalyst component, advantageously ACTA Hypermec 10010 catalyst (Ru/Al2O3).

### Heating:

The ammonia reformate is optionally then heated to the preferred temperature of 300 to 700° C., preferably 350 to 600° C., more particularly 400 to 500° C., for the H2 removal.

### Third Step

The reformate reaches the membrane module for H2 removal with a temperature of advantageously 300 to 700° C., preferably 350 to 700° C., preferably 350 to 600° C., preferably 400 to 600° C., more particularly 400 to 500° C. (see Y.-M. Lin et al. and Mejdell A. L., Jondahl M., Peters T. A., Bredesen R., Venvik H. J., “Effects of CO and CO2 on hydrogen permeation through a 3 mm Pd/Ag 23 wt. % membrane employed in a microchannel membrane configuration”, Separation and Purification Technology, 68 (2009) 178-184). High temperatures in the H2 membrane removal promote the transmission of the hydrogen through the membrane and reduce the inhibiting effect of the CO.

In the membrane module, the gaseous reformate is split into a high-purity hot permeate stream, having a purity of preferably >99.99 vol % H2, and into the retentate stream, which when using methanol contains H2, CO, CO2, H2O and unreacted MeOH and when using ammonia contains unreacted NH3 as well as the N2 and H2.

The gas composition of the retentate when using methanol is advantageously as follows: 5 to 40 mol % H2, 0.1 to 12 mol % CO, 5 to 66 mol % CO2, 1 to 12 mol % H2O and 0.1 to 10 mol % MeOH.

The gas composition in the retentate when using ammonia is preferably as follows: 5 to 35 vol % H2, 1 to 40 vol % NH3, 25 to 94 vol % N2, more preferably 10 to 25 vol % H2, 5 to 30 vol % NH3 and 45 to 85 vol % N2.

The H2 flow rate is advantageously 0.1 and 5.0 mol H2/(m2 s), preferably between 0.5 and 4.0 mol H2/(m2 s), more preferably between 1.0 and 3.5 mol H2/(m2 s), more particularly between 1.5 and 3.0 mol H2/(m2 s).

The temperature range for the H2 removal using membranes, advantageously Pd membranes, is advantageously between 40° and 700° C., more preferably between 45° and 600° C. and more particularly between 50° and 600° C.

The temperature of the third step, the hydrogen removal, in the case of methanol is advantageously higher by 10 to 400 K than the temperature of the second step, the reforming; this temperature difference is preferably 50 to 300 K, more particularly 75 to 200 K.

The second and third steps are carried out as successive, separate and independent process steps.

In the case of methanol, the CO partial pressure for the H2 removal using Pd membranes is advantageously between 0 and 5.0 vol %, more preferably between 0 to 2.0 vol % and more particularly between 0 and 0.5 vol %. A low CO partial pressure is achieved advantageously through the addition of water, a water-gas shift-active catalyst, and low temperatures, preferably 150 to 400° C., more particularly 200 to 250° C.

In the case both of methanol and of ammonia, the H2 partial pressure for the H2 removal using Pd membranes is advantageously between 50 and 80 vol %, more preferably between 60 and 75 vol % and more particularly between 65 and 70 vol %.

All three factors—a low CO partial pressure, a high H2 partial pressure, and a high temperature—reduce the separating effort involved in H2 removal.

As the material pairing, i.e., Pd film and carrier material, in the membrane apparatus it is advantageous to use Pd, Pd—Ag or Pd—Ag—Au, and ceramic or stainless steel (see A. Unemoto, A. Kaimai, S. Kazuhisa, T. Otake, K. Yashiro, J. Mizusaki, T. Kawada, T. Tsuneki, Y. Shirasaki and I. Yasuda, “The effect of co-existing gases from process of steam reforming reaction on hydrogen permeability of palladium alloy membrane at high temperatures”, International Journal of Hydrogen Energy, No. 32, pp. 2881-2887, 2007), an example being Pd with 20-30 wt % of Ag, more particularly with 23-24 wt % of Ag.

The Pd layer thicknesses are preferably between 1 and 60 μm, more preferably between 3 and 20 μm, more particularly between 5 and 10 μm.

Suitable membrane modules include in principle all known designs. Among the flat membranes, plate modules are one preferred design. As tubular membranes, capillary modules are preferred as well as hollow fiber modules. Particularly preferred are tube modules having diameters of 3 to 50 mm diameter, more particularly with 5 to 10 mm diameter.

The amount of H2 removed as permeate via the membrane is such as on the one hand to meet the purity requirements for the H2 product and on the other hand to give the retentate a sufficient heating value to be able to use it to provide the heat for the evaporation, for the reforming and, optionally, for the increase in temperature of the reformate prior to H2 removal.

The H2 content of the permeate is advantageously 95 to 99.999 vol % H2, more preferably 98 to 99.99 vol % H2, more particularly 99.0 to 99.95 vol % H2. The absolute pressure of the permeate is advantageously between 0.1 to 5 bar, more preferably between 0.5 and 3.0 bar, more particularly between 1.0 and 2.0 bar.

On the permeate side, steam may be used as a diluent gas for H2. The steam lowers the H2 partial pressure on the permeate side. The result is an increase in the driving pressure difference and in the H2 flow rate. This measure is advantageous if the PEM fuel cell has to be dampened continually during operation.

Besides the membrane module, advantageously no PSA unit (pressure swing adsorption) is used for removal of the hydrogen.

However, it may make good sense to ensure the purity of the permeate or to increase it further by passing the permeate over a bed of adsorber that removes the last remnants of CO, CO2, N2 and NH3 from the permeate. In that case this adsorber bed functions as a “policing filter”.

In the event that the CO content or CO2 content of the permeate does not meet the requirements of the fuel cell, moreover, the permeate may be routed advantageously via a methanation catalyst bed (see, e.g., WO 2004/002616 A2).

In or during the third process step itself there is advantageously a temperature increase of not more than 0 to 100° C., preferably of not more than 0 to 50° C., more preferably of not more than 0 to 20° C., more particularly no temperature increase and/or no further supply of energy. In the membrane module there are advantageously no units which have a higher temperature than the gaseous reformate, which undergoes intermediate heating if required. As a result of this measure, it is possible to prevent deposits, examples being coke deposits, particularly on the membrane surface.

The retentate is passed to a burner, which burns the combustible components in the retentate, more particularly (residual) methanol, carbon monoxide and hydrogen in the case of methanol, and (residual) ammonia and hydrogen in the case of ammonia, with the aid advantageously of heated air, in order to cover the energy required for the preheating, evaporation, reforming, and reformate heating prior to H2 removal. For this step, it is necessary to draw in air from the surrounding environment and compress it to a pressure which corresponds to the sum total of all the pressure losses in the gas line beginning from the burner through to the departure of the gas from the reformer module in the form of offgas. The sum total of all the pressure losses may be situated in the range from 50 mbar to 5 bar. Compressors used may be, for example, air blowers or else jet nozzles.

In one particular embodiment the ambient air may also be drawn in and compressed in an inexpensive jet nozzle, by expanding the retentate to the necessary pressure in the burner. This removes the need for the relatively expensive and power-consuming air compressor.

### Fourth Step

The mixture of retentate and heated air is subsequently burned in a burner, such as an atmospheric burner or catalytic burner, for example. The hot combustion gas, having advantageously a temperature of 500 to 1200° C. in the case of an atmospheric burner and having advantageously a temperature of 300 to 700° C. in the case of a catalytic burner, is routed via various heat exchangers in order (i) to heat the reformate, (ii) to provide the heat of reaction for the reforming, (iii) to provide the heat of evaporation for evaporating the methanol or the ammonia and (iiii) to provide for the preheating of the feedstock. It is possible optionally to omit the heating of the reformate (i).

After leaving the burner, the hot combustion gas is successively cooled advantageously down to a temperature difference, relative to the incoming feedstock stream of methanol or ammonia, of 1 to 200° C., preferably to 5 to 100° C., more preferably to 10 to 80° C., more preferably to 20 to 50° C., more particularly to 30 to 40° C. The combustion gas is cooled advantageously down to a temperature of 25 to 100° C., preferably to 35 to 60° C., more particularly to 40 to 50° C.

In one preferred embodiment, the energy required for the evaporation, the reforming, and optionally the raising of the reformate temperature may be provided by supplying the burner and/or the afterburner not only with the retentate but also with methanol or ammonia in the liquid and gaseous states. Supplying methanol or ammonia allows the overall process to be run advantageously and to be controlled during operation in a stable operating state. The admixing may take place advantageously before, after or directly in the air-conveying element.

The addition of methanol or ammonia is advantageously controlled via the sensible energy content of the offgas, i.e., of the cooled combustion gas departing the process, and the temperature of the combustion gases from the burner and the optional afterburner. All of this together produces the energy provided for the evaporation, the reforming, and optionally the raising of the temperature prior to H2 removal. If, for example, there is a drop in the burner temperature or in the amount of offgas, the burner is advantageously supplied with methanol or ammonia. The amount of methanol or ammonia needed may vary greatly. The amount of methanol or ammonia supplied to the burner is advantageously between 0% and 30%, preferably between 0% and 20%, preferably between 0% and 10%, more particularly between 0% and 5% of the amount of methanol or ammonia supplied to the overall process.

The air required for the burner is drawn advantageously from the surrounding environment. The air drawn in is then advantageously compressed for the conveying of the hot combustion gas via the heat exchangers. The air is compressed advantageously from ambient pressure (1.013 bar) to 1.05 to 5.0 bar, preferably to 1.1 to 2.0 bar, more particularly 1.2 to 1.5 bar. Suitable compressors include all of the apparatuses known to the skilled person, such as, for example, aerators, fans, compressors, etc. The compressor is situated advantageously ahead of the first burner.

In one particular embodiment, for the necessary pressure increase of the ambient air ahead of the burner and for the conveying of the hot combustion gas via the heat exchangers, no conveying element is used that requires electrical energy, such as an aerator or a compressor, for example. Use is made advantageously of a jet pump (see https://www.koerting.de/de/strahlpumpen.html?gclid=EAIa IQobChMI7M21hpmw8AIVB-d3Ch0YTgJLEAAYASAAEgKG-fD_BwE), which, with the high pressure of advantageously 5 to 40 bar of the retentate, draws in the ambient air and compresses it to the required pressure of advantageously 0.05 to 5 bar. This allows the reformer module to be operated self-sufficiently, i.e., without external energy sources, apart from the conveying of the crude condensate, which requires only very little energy.

The hot combustion gas produced in the burner advantageously has, when using an atmospheric burner, a temperature of 600° C. to 1100° C., preferably 700° C. to 1000° C., more preferably 800 to 950° C., more particularly 850 to 900° C., and when using a catalytic burner advantageously has a temperature of 200 to 500° C., preferably 220 to 300° C.

When using methanol, the combustion gas contains advantageously H2O, CO2, N2 and residual O2. The composition of the combustion gas is advantageously as follows: 5 to 16 vol % O2, 24 to 78 vol % N2, 3 to 35 vol % CO2, 3 to 36 vol % H2O, more preferably 10 to 15 vol % O2, 49 to 68 vol % N2, 8 to 20 vol % CO2, 9 to 21 vol % H2O, and more particularly 14 vol % O2, 68 vol % N2, 9 vol % CO2, 9 vol % H2O.

When using ammonia, the combustion gas contains advantageously N2, 02 and H2O. The composition of the combustion gas is, illustratively, as follows: 80 vol % N2, 10 vol % O2 and 10 vol % H2O.

In all cases, the composition of the combustion gas is controlled advantageously through the residual O2 concentration. Small O2 values denote small combustion gas volume flows (low compression effort), but a high initial temperature of the combustion gas. Large O2 values (not more than 21 vol %) have the opposite effect.

The flow regime of the combustion gas is represented in FIG. 4.

The hot combustion gas passes successively through a number of heat exchangers, (0) optionally for the heating of the reformate, (i) the reforming, (ii) the evaporation of the condensate, and (iii) optionally the preheating of the ammonia feed, methanol feed or methanol-water feed, and it is cooled gradually almost to ambient temperature (see FIGS. 2 to 4).

Between the reformer reactor and the membrane module, and also between the membrane module and the air-conveying element, it is possible advantageously to install further heat exchangers, in order, for example, to improve the heat integration or the H2 removal ratios via the Pd membrane.

The cooling of the combustion gas after the atmospheric burner takes place advantageously with the following entry temperature ranges of the combustion gas for the methanol regime: Without intermediate heating of the combustion gas in the afterburner: Variant without reformate heater (see FIG. 2): reformer 700 to 900° C., evaporator 500 to 650° C., preheater 150 to 220° C.

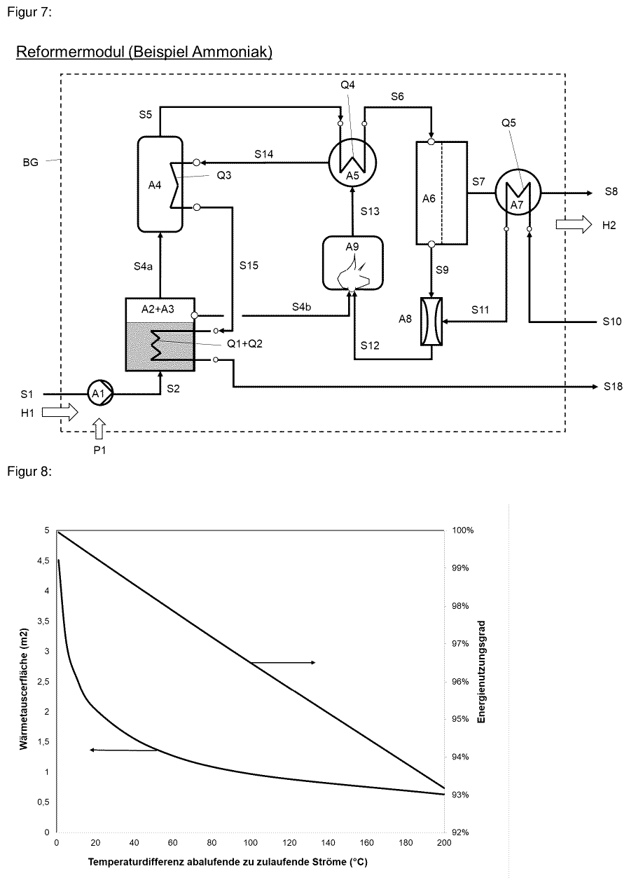

Variant with reformate heater (see FIG. 7): reformate heater 700 to 900° C., reformer 400 to 700° C., evaporator 300 to 500° C., preheater heat exchanger 150 to 220° C.

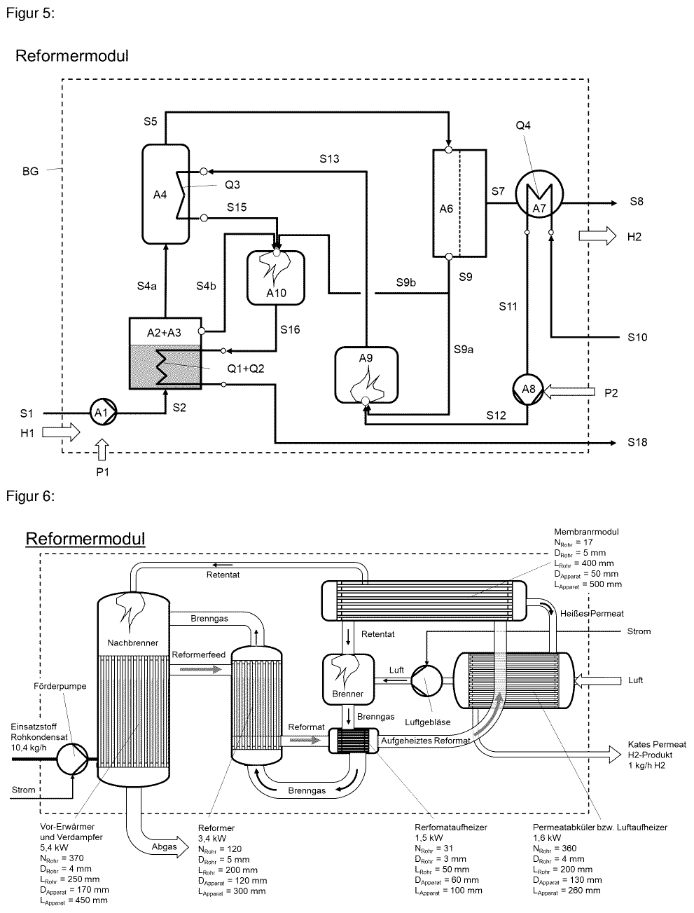

With intermediate heating of the combustion gas after the reformer heat exchanger by an afterburner: Variant without reformate heater (see FIG. 5): reformer 700 to 900° C., evaporator 500 to 650° C., preheater 150 to 220° C.

Variant with reformate heater (see FIG. 4): reformate heater 700 to 900° C., reformer 700 to 900° C., evaporator 300 to 700° C., preheater 150 to 220° C.

The cooling of the combustion gas after the atmospheric burner takes place advantageously with the following entry temperature ranges of the combustion gas for the ammonia regime: Without intermediate heating of the combustion gas in the afterburner: Variant without reformate heater (see FIG. 2): reformer 700 to 1200° C., evaporator 500 to 650° C., preheater 150 to 220° C.

Variant with reformate heater (see FIG. 7): reformate heater 700 to 1200° C., reformer 400 to 700° C., evaporator 300 to 500° C., preheater heat exchanger 150 to 220° C.

With intermediate heating of the combustion gas after the reformer heat exchanger by an afterburner: Variant without reformate heater (see FIG. 5): reformer 700 to 1200° C., evaporator 500 to 650° C., preheater 150 to 220° C.

Variant with reformate heater (see FIG. 4): reformate heater 700 to 1200° C., reformer 700 to 900° C., evaporator 300 to 700° C., preheater 150 to 220° C.

Using catalytic burners, these burners are integrated advantageously into heat exchangers. The first catalytic burner is preferably integrated into the reformer heat exchanger or—using a reformate heat exchanger—into that reformate heat exchanger (FIGS. 2, 4, 5 and 7).

Advantageously, furthermore, two catalytic burners are used, integrated preferably in the reformate and reformer heat exchanger or in the reformer and evaporator heat exchanger. Advantageously, furthermore, three catalytic burners are used, integrated preferably in the reformate, reformer and evaporator heat exchanger.

Multiple catalytic burners may advantageously have a common air supply or separate air supplies.

In the catalytic burner, the temperature remains approximately constant over the entire flow pathway. The temperature on the combustion side is advantageously 1 to 300° C., preferably 5 to 50° C., above the temperature in the reformer (200 to 500° C.) and in the evaporator (130 to 220° C.); in other words, the temperature on the combustion side is 200 to 700° C. in the reformer and 130 to 520° C. in the evaporator.

In parallel, advantageously, the permeate of the membrane module, the hydrogen removed, which has a temperature of 300 to 700° C., is cooled in the permeate cooler, by preheating the air that is drawn in for the burner. In this way the hot permeate stream is cooled to a temperature difference, relative to the incoming air stream, of 1 to 200° C., preferably to 5 to 100° C., more preferably to 10 to 80° C., more preferably to 20 to 50° C., more particularly to 30 to 40° C. This step is of great importance for the energy efficiency of the reformer module.

The streams which leave the process, i.e., the cooled permeate stream and the burner offgas, advantageously have the following temperatures: 25 to 100° C., preferably 25 to 80° C., more particularly 25 to 50° C.

In a given apparatus, the offgas temperatures may be controlled advantageously via the volume flow of air and/or via the combustion gas temperatures. If the combustion gas temperature is too high, the volume of air drawn in is advantageously increased. If the amount of product is too low, the regulating streams S4b and S9b are advantageously increased.

In the interest of a high energy efficiency, small volume flows of air are better than large ones. Small volume flows of air, however, result in high combustion gas temperatures, e.g., 1100 to 1200° C. The combustion gas temperature is limited by the temperature stability of the materials used for the heat exchangers and gas conduits, to 1100 to 1200° C.

For the regulation of the process, preference is given to measuring the offgas quantity S18 and the H2 product quantity S8 and also the temperatures in the gas flows S13, S16 and S18. The incoming volume flow S1 is regulated preferably via the amount of H2 product. The gas temperatures are regulated by the volume flow of air drawn in, S10, and by the regulating streams S4b and S9b.

### Design of the Heat Exchangers

The logarithmic mean temperature difference (LMTD), which is used to design heat exchangers, is advantageously as large as possible between the heat-exchanging streams at every location in the heat exchanger. The difference is advantageously from 1 to 100° C., preferably 10 to 50° C.

A high temperature difference in the evaporator heat exchanger may be realized advantageously by intermediate heating of the combustion gas downstream of the reformer heat exchanger in an afterburner, advantageously to 280 to 800° C., for example, preferably 350 to 700° C., more particularly 550 to 650° C., as represented in FIGS. 4 and 5.

For this purpose, in the afterburner, the cooled combustion gas from the burner, which still contains residual oxygen, is supplied advantageously with a part of the retentate stream, for example 5 to 40 vol %, preferably 20 to 30 vol %, and advantageously with a methanol or methanol-water stream or an ammonia stream from the evaporator, for example 0.1% to 20%, preferably 0.5% to 10%, more particularly 1% to 5% of the evaporated methanol or ammonia.

As afterburners as well all designs known to the skilled person are suitable, such as catalytic burners, atmospheric burners and blower burners, for example. If a catalytic afterburner is used, it is integrated advantageously into the evaporator heat exchanger.

With this measure, the heat exchanger area of the evaporator and the combustion temperature in the first burner can be advantageously reduced. The advantage is that on the one hand the heat exchanger for the evaporator is much the largest and on the other hand the gas temperatures of well above 900° C. in the first burner that would be otherwise necessary would be realizable only using very expensive materials.

The following regime for the flows is advantageous:

TABLE 1
Preferred embodiment of the heat exchangers

| | | | Pressure | |
|---|---|---|---|---|
| | | In the | range, | Temperature |
| Heat | In the | exterior | exterior | range, exterior |
| exchanger | tubes | chamber | chamber | chamber |
| Preheater | Combustion | MeOH or | 4 to | 25 to 220° C. |
| | gas | NH3 | 60 bar | (MeOH and NH3) |
| Evaporator | Combustion | MeOH or | 4 to | 130 to 220° C. |
| | gas | NH3 | 60 bar | (MeOH) |
| | | | | 25 to 100° C. |
| | | | | (NH3) |
| Reformer | Combustion | MeOH or | 4 to | 200 to 400° C. |
| | gas | NH3 | 60 bar | (MeOH) |
| | | | | 200 to 700° C. |
| | | | | (NH3) |
| Reformate | Reformate | Combustion | 1 to | 600 to 900° C. |
| heater | | gas | 5 bar | (MeOH) |
| | | | | 500 to 1200° C. |
| | | | | (NH3) |
| Permeate | Air | H2 | 1 to | 25 to 700° C. |
| cooler and/ | | | 5 bar | (MeOH and NH3) |
| or air heater | | | | |

In the heat exchanger of the reforming, the reformer heat exchanger, the catalyst and the methanol/water vapor or ammonia vapor are sited preferably in the exterior chamber, and the combustion gas is routed through the tubes. The pressure in the reaction chamber is preferably 3 to 60 bar higher, preferably 10 to 30 bar higher, than the pressure in the combustion gas chamber.

In the event of an increase in the temperature of the raffinate ahead of the membrane separation unit, in the reformate heater, the raffinate flows preferably in the tubes, and the combustion gas in the exterior chamber.

In the event of air preheating, in the air heater and/or permeate cooler, by cooling of the hot permeate, the air is routed preferably through the tubes, and the H2 in the exterior chamber.

In the event of the preheating and evaporation of the liquid feedstock—methanol or methanol-water mixture or ammonia—ahead of the reforming, the combustion gas is routed preferably in the tubes, and the liquid methanol or methanol-water mixture or the liquid ammonia in the exterior chamber.

A further possibility is for the retentate from the fuel cell, which possibly still contains unreacted H2, to be recirculated into the reformer, to be utilized therein for energy and hence to achieve a further increase in the overall efficiency for the system as a whole.

The preferred tube diameters for all heat exchangers are between 1 and 6 mm, more preferably between 2 and 5 mm, more particularly between 3 and 4 mm (see EP 2526058 B1).

Other cross-sectional shapes as well, such as the rectangular channel, for example, are equivalent to these tube geometries.

The microapparatuses are frequently made with rectangular channels, for manufacturing reasons. In principle, the process of the invention can be implemented not only in milliapparatuses but also in microapparatuses. The choice of milli or micro technology is dependent in particular on the required performance of the reformer module, the required ease of maintenance, and the space conditions that are present. A change of catalyst, for example, is easier to accomplish with millireactors than with microreactors.

Through the process of the invention it is possible to achieve levels of energy utilization of advantageously 95% to 99.8%, preferably 98% to 99.5%.

A further aspect of the invention relates to an apparatus for obtaining high-purity hydrogen from methanol or ammonia, for fuel cell operation, in accordance with the process described above (see FIG. 6).

The apparatus for the process described comprises in one embodiment:
an apparatus for preheating the methanol or the methanol-water mixture or the ammonia, usually integrated in the downstream evaporator
an evaporation apparatus
a reforming reactor
a membrane apparatus
at least one burner
at least three heat exchangers, advantageously four heat exchangers, preferably five heat exchangers
means for introducing and/or discharging fluids on the apparatus for heating, on the evaporation apparatus, on the reforming reactor, on the membrane apparatus, on the burner or burners, on the heat exchangers.

### Advantages

The external energy balance in the process of the invention is determined exclusively by the energies stored in the imported and exported streams. For the theoretical limiting case whereby the imported streams of methanol/water or ammonia and air have the same temperature as the exported streams of H2 product (cold permeate) and offgas and whereby the methanol or ammonia already possesses the reforming pressure, the resulting efficiency for this reformer module is 100%.

Since no additional energy is imported from outside and no excess energy is delivered to the outside, the H2 product stream must possess the same heating value as the methanol or ammonia feedstocks. In the case of this reformer module of the invention, therefore, there is theoretically no loss of conversion energy. Losses arise merely as a result of the fact that the exported streams are hotter than the imported streams, and through heat given off via the apparatus walls to the surrounding environment, and also by the mechanical output of the liquid pump and of the air-conveying element. Effective heat integration and a low loss of flow pressure on the part of the combustion gas are therefore important. Advantageously, furthermore, all of the apparatuses of the reformer module are located in a well-insulated containment, with vacuum insulation, for example, in other words with precompressed, fleece-clad plates or sleeves made of microporous silica which have been welded under reduced pressure into a film that is impervious to gas and water vapor.

### FIGURES AND REFERENCE SYMBOLS

TABLE 2
Assignment of the material stream names used in the text with
the material stream designations used in the figures.

| Designation | Material stream name used in the text |
|---|---|
| S1 | Feedstock from tank (methanol, crude condensate, |
| | ammonia) |
| S2 | Feedstock post conveying pump |
| S3 | Preheated feedstock |
| S4a | Reformer feed |
| S4b | Regulating stream |
| S5 | Reformate |
| S6 | Heated reformate |
| S7 | Hot permeate |
| S8 | Cold permeate (H2 product) |
| S9 | Retentate |
| S9a | Retentate to burner A9 |
| S9b | Retentate to burner A10 |
| S10 | Air |
| S11 | Heated air |
| S12 | Heated air post air-conveying element A8 to burner |
| S13 | Hot combustion gas from burner |
| S14 | Cooled combustion gas post reformate heater |
| S15 | Further-cooled combustion gas post reformer |
| S16 | Intermediately heated combustion gas post afterburner |
| S17 | Cooled combustion gas post evaporator |
| S18 | Offgas |

TABLE 3
Assignment of the apparatus names used in the text with the apparatus
designations used in the figures. Apparatus designations in the
form A1-k, A2-k, etc., always represent the flow side of the colder
stream in the corresponding heat exchanger. Apparatus designations
in the form A1-h, A2-h, etc., always represent the flow side of
the hotter stream in the corresponding heat exchanger.

| Designation | Apparatus name used in the text |
|---|---|
| A1 | Conveying pump |
| A2 | Preheater |
| A3 | Evaporator |
| A4 | Reformer |
| A5 | Reformate heater |
| A6 | Membrane module |
| A7 | Permeate cooler or air heater |
| A8 | Air-conveying element (air compressor, air blower or |
| | jet nozzle) |
| A9 | Burner |
| A10 | Afterburner |
| BG | Balance boundary for the reformer module |

TABLE 4
Assignment of the heat flow names used in the text with
the heat flow designations used in the figures.

| Designation | Heat flow explanations used in the text |
|---|---|
| Q1 | Preheating of feedstock S2-S3 by cooling of combustion |
| | gas S17-S18 |
| Q2 | Evaporation of feedstock S3-S4 by cooling of combustion |
| | gas S16-S17 |
| Q3 | Reforming S4a-S5 by cooling of combustion gas S14-S15 |
| Q4 | Heating of reformate S5-S6 by cooling of combustion gas |
| | S13-S14 |
| Q5 | Heating of air S10-S11 by cooling of permeate S7-S38 |

TABLE 5
Assignment of the names used in the text for flow
machines with the designations used in the figures.

| Designation | Names used in the text for flow machines |
|---|---|
| P1 | Mechanical power consumption of conveying pump |
| P2 | Mechanical power consumption of air-conveying element |

TABLE 6
Assignment of the names used in the text for energy
flows with the designations used in the figures.

| Designation | Names used in the text for energy flows |
|---|---|
| H1 | Enthalpy of feedstock stream |
| H2 | Enthalpy of H2 product stream |

### 1st Example—Methanol

FIG. 6 shows, illustratively, the process of the invention for the performance of 1 kg H2/h, including the optimal geometric dimensions as ascertained for the key apparatuses in the reformer module on the basis of a model calculation.

For a fuel cell vehicle which, operated with H2, has a tank-to-wheel efficiency of 60%, 1 kg of H2 is provided hourly from a reformer module. 1 kg H2/h corresponds to a power of 33.3 kW and, after conversion in an FC, to an electrical power of 20 kW. A mid-range automobile requires this power on average for 100 km.

The example is calculated without heat losses via the device wall of the reformer module.

According to the process of the invention, this requires the reformer module to be supplied hourly with 10.4 kg of crude condensate, i.e., a methanol-water mixture with a molar ratio of 1:1, which must be pumped with the conveying pump to the system pressure of 20 bar. This increase in pressure requires P1=0.02 kWₑ₁ of electrical power.

By routing crude condensate and combustion gas in countercurrent in the evaporator, both the preheating of the crude condensate and the evaporation can take place in said evaporator. The two processes together require 5.4 kW of thermal power. The boiling temperature of the crude condensate at 20 bar is 188° C. 10.1 kg of crude condensate vapor are supplied as reformer feed to the reformer, and 0.3 kg/h is supplied as a regulating stream to the afterburner.

In the reformer, the crude condensate vapor is brought to the reaction temperature of 240° C. and reformed catalytically to give 68.7 vol % H2, 2.7 vol % CO and 21.7 vol % CO2. The equilibrium conversion of MeOH at 240° C. and 20 bar is 93%. The reformate additionally contains 5.2 vol % of unreacted H2O and 1.7 vol % of unreacted MeOH. The reforming requires 3.8 kW of thermal energy.

The reformate is subsequently heated in the reformate HE (reformate heater) to 450° C. The heating requires 1.5 kW of thermal power.

In the membrane module, 1 kg of hot permeate is removed hourly, and cooled to 45° C. in the permeate cooler or air heater. The cold permeate leaves the reformer module as the H2 product. This requires a thermal power of 1.6 kW.

9.1 kg of retentate leave the membrane module hourly, with 11.0 vol % H2, 7.6 vol % CO, 61.8 vol % CO2, 14.8 vol % H2O and 4.8 vol % MeOH. Of this, 5.8 kg/h are supplied to the burner and 3.3 kg/h to the afterburner. The burner requires 18.6 kg/h of air, which is heated to 330° C. in countercurrent to the permeate in the permeate cooler or air heater, and then, for the purpose of overcoming all of the flow losses, is compressed in an air-conveying element to 1.5 bar. This is accompanied by an increase in temperature to 420° C. The H2 product stream, as cold permeate at 45° C., leaves the permeate cooler or air heater and subsequently leaves the reformer module.

5.8 kg of retentate are burned with the compressed air in the burner on an hourly basis. This produces a hot combustion gas in a flow rate of 24.4 kg/h and with a temperature of 900° C. This combustion gas heats the reformate in the reformate heater with a thermal power of 1.5 kW and is cooled in the process to 720° C. The cooled combustion gas stream is subsequently passed into the reformer, where it supplies a thermal power of 3.8 kW for the reforming reaction and it heats the gaseous reformer feed from 188 to 240° C.

The further-cooled combustion gas subsequently undergoes intermediate heating in the afterburner back to 650° C. For this purpose, the cooled combustion gas, which still contains around 14 vol % of oxygen, is admixed with 3.3 kg/h of retentate and 0.3 kg/h of regulating stream from the evaporator, and burned.

In the evaporator and preheater, the intermediately heated combustion gas cools down to 45° C. in countercurrent to the cold crude condensate supplied and leaves the reformer module as offgas.

With the crude condensate feedstock, the reformer module is supplied with a stream having an enthalpy of 33.04 kW. In addition it is necessary to supply a further 0.52 kW of electrical power for the conveying pump and the air blower. A total of 33.56 kW flows into the reformer module, and an H2 product stream with an enthalpy of 33.33 kW leaves the reformer module.

The energetic efficiency of the overall process η_{Pr} is defined as follows:

$${η}_{Pr} = {m}_{H 2} * {H}_{UH , H 2} / {m}_{MeOH} ⋆ {H}_{UH , MeOH}$$

with the mass of H₂ in kg/h obtained from the MeOH mass flow engaged, m_{MeOH}, in kg/h, and with the associated lower heating values of H_{UH,H2}=120 MJ/kg and H_{UH,MeOH}=19.9 MJ/kg.

Disregarding the heat losses via the device wall of the reformer module, the energetic efficiency η_{Pr}=33.33 kW/33.56=99.3%.

Taking account of the FC efficiency of 60%, the tank-to-wheel efficiency for the vehicle is then 60%*99.3%=59.6%.

If the degree of energy utilization of the process of the invention, including the efficiency of the FC of 60%, is compared with the prior art (SIQENS Fuel Cell Technology, “SIQENS Ecoport 800, Energie fir Off-Grid, Notstrom und Mobilität” [SIQENS Ecoport 800, Energy for off-grid, backup, and mobility], 2021. [Online]. [Accessed on 09 06 2021]), then the energetic and hence economic advantage of the invention becomes apparent.

| | |
|---|---|
| Direct fuel cell | 30-40% |
| Emonts et al. | 56.0% |
| Invention | 59.6% |

Reported in FIG. 6 for each material-exchanging or heat-exchanging apparatus, as well as the thermal power Pₜₕₑᵣₘ, are the tube number N_{tube}, the tube internal diameter D_{tube}, the active tube length L_{tube}, the apparatus diameter Dₐₚₚₐᵣₐₜᵤₛ, the apparatus length Lₐₚₚₐᵣₐₜᵤₛ, and the pressure loss of the gases flowing through the tubes, Dpv.

| | Pₜₕₑᵣₘ | N_{tube} | D_{tube} | L_{tube} | Dₐₚₚₐᵣₐₜᵤₛ | Lₐₚₚₐᵣₐₜᵤₛ | Dp_{V} |
|---|---|---|---|---|---|---|---|
| Apparatus | kW | (—) | mm | mm | mm | mm | mbar |
| Preheater | 5.4 | 370 | 4.0 | 250 | 170 | 450 | 25 |
| and | | | | | | | |
| evaporator | | | | | | | |
| Reformer | 3.4 | 120 | 5.0 | 200 | 120 | 300 | 30 |
| Reformate | 1.5 | 31 | 3.0 | 50 | 60 | 100 | 14 |
| heater | | | | | | | |
| Permeate | 1.6 | 360 | 4.0 | 200 | 180 | 260 | 11 |
| cooler or | | | | | | | |
| air heater | | | | | | | |
| Membrane | — | 17 | 5.0 | 400 | 50 | 500 | — |
| module | | | | | | | |

For the simulation, a compression power for the air stream of 500 mbar was assumed, since the control valves needed for regulation of the process require a certain pressure loss range. Starting from the air supply through to the removal of the offgas, the net pressure loss for the gas stream (without control valves) is 80 mbar.

For H2 product streams other than 1 kg/h, different preferred tube numbers and geometries are produced. The stated preferred tube diameters, however, remain unaffected in this case. The only changes are in the number of tubes N_{tube} and the tube lengths L_{tube} and hence in the apparatus diameter Dₐₚₚₐᵣₐₜᵤₛ and the apparatus length Lₐₚₚₐᵣₐₜᵤₛ.

These values were ascertained according to equations which are known to the skilled person and are described in the VDI-Wärmeatlas (Verein Deutscher Ingenieure, “VDI-Wärmeatlas” [VDI Heat Atlas], 11 edition, H. V. V. u. C. (GVC), eds., 2013, pp. 1223-1225).

### 2nd Example—Ammonia

In terms of the amounts and the energies, the example is the result of a thermodynamic simulation using an in-house BASF simulator in analogy to the Aspen Plus simulation program.

To calculate the H2/N2 separation with the Pd membrane, an Excel calculating tool was used, the calculating protocol of which is described in Saltonstall (C. Saltonstall, “Calculation of the Membrane Area Required for Gas Separations”, vol. 32, pp. 185-193, 1987).

Flow pressure losses are not included in this calculation, since this example calculation is not based on any design of apparatus. This example calculation illustrates the potential of the process of the invention.

The example is represented in FIG. 7: Liquid NH3 is held in a storage tank at ambient temperature (25° C.). To generate 1000 kg of H2/h, 6891 kg/h of NH3 are pumped with a conveying pump to an evaporator with integrated preheater and are evaporated at 20 bar. For that purpose it is necessary to supply 7 kW of pumping power and 1920 kW of thermal energy at 49.3° C.

The equilibrium conversion of the NH3 vapor at 400° C. and 20.0 bar is 86.0%. The heating of the NH3 vapor to reaction temperature and the reforming itself require a heat flow of 6700 kW. The molar composition of the reformate may be as follows: 69.3 vol % H2, 23.1 vol % N2 and 6.9 vol % NH3.

The reformate is heated further in the reformate heater to 450° C. This requires a heating power of 320 kW.

The heated reformate is subsequently passed into a membrane module whose Pd membrane possesses specific values, as are published in Macchi et al. (G. Macchi and D. Pacheco Tanaka, “Flexible Hybrid separation system for H2 recovery from NG Grids”, in WP10-Exploitation workshop D10.16, 2016) and Melendez et al. (J. Melendez, E. Fernandez, F. Gallucci, M. van Sint Annaland, P. Arias and D. Tanaka, “Preparation and characterization of ceramic support ultrathin Pd—Ag membranes”, Journal of Membrane Science, vol. 528, pp. 12-23, 2017). Accordingly the Pd—Ag membrane, with a layer thickness of 5 micrometers, possesses an H2 permeance at 450° C. of 6.9*10-7 mol m-2 s-1 Pa-1 and an ideal H2/N2 selectivity of >150 000.

Using the membrane, 1000 kg/h of H2 are removed as a hot permeate from the heated reformate at 450° C. The molar composition of the retentate (5890 kg/h) is then as follows: 10.0 vol % H2, 67.8 vol % N2 and 22.2 vol % NH3. The molar H2 concentration in the retentate of 10.0% corresponds to a mass flow rate of 52 kg/h of H2. Of the H2 quantity of 1052 kg/h generated in the NH3 cleavage, 1000 kg/h of H2 are recovered.

In the case of a pressure on the permeate side of 1.0 bar, the separation requires an area of 166 m². The permeate possesses a purity of >99.99 H2 and is cooled in the permeate cooler or air heater from 450° C. to 45° C., before it leaves the overall process as an H2 product stream. For this purpose it is necessary to withdraw 1620 kW from the hot permeate stream.

The retentate is expanded from 20.0 bar to 1.2 bar, and, in the process, it compresses 27 460 kg/h of heated air from 1.0 to 1.2 bar for the combustion of the retentate, using a jet nozzle with a 25% efficiency.

The resultant mixture (33 350 kg/h) is burned and as a combustion gas at 900° C. leaves the burner, before being cooled gradually to 71° C. In the first step, 320 kW are needed for the heating of the reformate from 400 to 450° C., while the second step requires 6700 kW for the heating of the reformer feed from 49.3° C. to reaction temperature and for the NH3 reforming itself. In this case the combustion gas cools down to 261° C. Lastly the combustion gas is cooled to 71° C., by evaporation of the liquid NH3.

Liquid NH3 possesses a lower heating value of 4.90 MWh/kg, and H2 possesses a lower heating value of 33.33 MWh/kg. The process is therefore supplied with 6891 kg/h*4.90 MWh/kg=33 766 MW plus 7 kW of pumping power, and 1000 kg/h*33.33 MWh/kg=33 333 MW in the form of H2 are recovered. The degree of energy utilization of the overall process is therefore 98.7%.

A comparison of the degree of energy utilization of the process of the invention with the prior art when using a Pd membrane without PSA provides an overview of the energetic and therefore economic advantages of the invention:

| | |
|---|---|
| GB 1,079,660 | 65% |
| WO 2018/235059 A1 | <78% |
| WO 02/071451 A2 | 85% |
| L. Lin et al. | <80% |
| Lamb et al. | 90% |
| Invention | >98% |

### 3rd Example—Comparison of the Present Invention with the Membrane Reactor Technology of U.S. Pat. No. 5,741,474: i.e., Reformer and H2 Removal at the Same Temperature Versus Reformer and H2 Removal Each at Optimal Temperature

The process of the invention, wherein the reforming and the H2 removal via a membrane each take place at the optimal temperature for the individual process step, is compared, illustratively, with processes wherein the two process steps are required by the nature of the system to operate at the same temperature, as in the case of a membrane reactor.

The example is calculated for the production of 1000 kg/h of H2 via methanol reforming and H2 removal via a Pd membrane, and, in terms of the amounts and the energies, is the result of a thermodynamic simulation using an in-house BASF simulator in analogy to the Aspen Plus simulation program.

For the purpose of calculating the H2 removal with the Pd membrane, an Excel calculating tool was used, programmed with a calculating protocol as described in the publication by C. Saltonstall in “Calculation of the Membrane Area Required for Gas Separations”, vol. 32, pp. 185-193, 1987.

Flow pressure losses are not included in this calculation, since this example calculation is not based on any design of apparatus.

Two cases are compared:
Case 1: Reforming and H2 removal take place at the same temperature, each at 250° C.
Case 2: Reforming and H2 removal take place at the same temperature, each at 450° C.
Case 3: Reforming and H2 removal take place at different temperatures—reforming at 250° C. and H2 removal at 450° C.

In all of the cases, the reformer and the H2 removal operate at 15 bar.

### Results

| | Case 1 | Case 2 | Case 3 |
|---|---|---|---|
| Reformer temperature (° C.) | 250 | 450 | 250 |
| Degree of energy utilization (%) | 93.5 | 91.7 | 93.5 |
| H2 removal temperature (° C.) | 250 | 450 | 450 |
| Membrane area (m2) | 916 | 257 | 224 |
| Pd requirement (5 μm layer thickness) (g) | 54.9 | 15.4 | 13.4 |
| Risk of coking | low | high | low |

The results show that the adaptation of the temperature to the respective process step is advantageous:

As the temperature in the reformer increases, the degree of energy utilization goes down, since at higher temperature it is necessary to supply the reformer with more energy than at a lower temperature. The degree of energy utilization is the ratio of the heating value of the hydrogen product to the heating value of the methanol feed engaged. While the degree of energy utilization at a reformer temperature of 450° C. is 91.7% (case 2), it rises to 93.5% for a reformer temperature of 250° C. (cases 1 and 3).

With rising temperature for the removal of H2 via a Pd membrane, there is a reduction in the required membrane area and, directly connected thereto, in the Pd required for the coating of the membrane. Whereas a membrane area of 257 m2 (case 2) or 224 m2 (case 3) is sufficient for H2 removal at a temperature of 450° C., the increase in the membrane area required for the lower temperature of 250° C. is an increase of three and a half times to 916 m2 (case 1). Correspondingly there is also an increase in the Pd requirement, from 15.4 g (case 2) or 13.4 g (case 3) to 54.9 g (case 1).

In both cost-relevant categories, therefore, the process of the invention (case 3), which on the basis of the process-engineering separation of reforming and H2 removal permits an optimal adaptation of the temperatures to the requirements of the two process steps, possesses advantages over a process as represented by the membrane reactor for which this is not possible.

### 4th Example—Methanol Temperature Differences of the Incoming and Outgoing Streams

FIG. 8 shows the effect of the temperature difference of the outgoing streams S8 and S18 relative to the incoming streams S10 and S1 on the heat exchanger areas of the apparatuses A7 and A2+A3 and also on the degree of energy utilization. For this purpose, the temperature differences of the process described in example 1 were varied. The results are based on the model calculation stated in example 1. For the sake of simplicity, in all cases, the temperature differences between S8 and S10 and also between S18 and S1 were always selected to be the same—in other words, it is always the case that S8-S10=S18-S1.

While the degree of energy utilization increases linearly with decreasing temperature difference, the heat exchanger area increases exponentially with decreasing temperature difference. FIG. 8 teaches that a temperature difference of more than 100° C. does not lead to a marked reduction in the heat exchanger areas, but does lead to a marked deterioration in the degree of energy utilization. Conversely, a reduction in the temperature difference to below 10° C. is accompanied not by any marked improvement in the degree of energy utilization, but by a more-than-proportional increase in the required heat exchanger areas in A7 and A2+A3. The conclusion from this is that the process of the invention is to have a preferred temperature difference between the outgoing streams S8 and S18 and the incoming streams S10 and S1 of 5 to 100° C., preferably between 1° and 80° C., more preferably between 15 and 60° C., and more particularly between 2° and 40° C.

1. A process for obtaining hydrogen from methanol or ammonia, wherein methanol or ammonia is subjected to evaporation in a first step and in a second step to reforming to give a hydrogen-containing gas mixture, in a third step hydrogen is removed from this gas mixture in a membrane process at a temperature of 300 to 600° C. and in a fourth step the gaseous retentate from the membrane process is burned with ambient air, wherein the second step is a process step upstream of and separate from the third step and the combustion gases are routed via at least two different heat exchangers to provide, in the flow direction of the combustion gases, (i) first the reaction heat for reforming the methanol or ammonia and (ii) then the evaporation heat for evaporating the reformer feed, wherein the permeate from the membrane process preheats the ambient air for the burner in a heat exchanger, the temperature differences between (a) the outgoing permeate and the incoming ambient air and (b) the outgoing combustion gas and the incoming methanol or ammonia each being between 1 and 200° C., and wherein during the third process step there is a maximum temperature increase of 0 to 100° C.

2. The process according to claim 1, wherein the combustion gases are routed via at least three different heat exchangers (0) first, in the flow direction of the combustion gases, to heat the reformate gas, then to provide (i) the reaction heat for reforming the methanol or ammonia and lastly (ii) the evaporation heat for evaporating the methanol or ammonia.

3. The process according to claim 1, wherein the conversion in the reforming is 80% to 95%.

4. The process according to claim 1, wherein in the evaporator heat exchanger the methanol or the ammonia is routed in the exterior chamber of the heat exchanger and the combustion gas is routed through the tubes of the heat exchanger.

5. The process according to claim 1, wherein the ambient air is drawn in by means of a jet pump.

6. The process according to claim 1, wherein the temperature differences between (a) the outgoing permeate and the incoming ambient air and (b) the outgoing combustion gas and the incoming methanol or ammonia are each between 5 and 100° C.

7. The process according to claim 1, wherein during the third process step there is a maximum temperature increase of 0 to 50° C.

8. The process according to claim 1, wherein in the third step hydrogen is removed in a membrane process at a temperature of 400 to 600° C.

9. The process according to claim 1, wherein between the reformer heat exchanger and the evaporator heat exchanger, the combustion gas is subjected to intermediate heating with a second burner.

10. The process according to claim 1, wherein the burner is supplied with methanol or ammonia as well as with the retentate from the membrane process.

11. The process according to claim 1, wherein, with use of methanol, the combustion gases are routed via at least four different heat exchangers first, in the flow direction of the combustion gases, (i) to heat the hydrogen-containing gas mixture from the reforming, (ii) then to provide the reaction heat for the reforming and (iii) subsequently the evaporation heat for evaporating the reformer feed, and (iv) lastly to preheat the methanol or the methanol-water mixture.

12. The process according to claim 1, wherein, with use of ammonia, the combustion gases are routed via at least three different heat exchangers, either:
in the flow direction of the combustion gases, (0) first to provide the reaction heat for reforming the ammonia, then (i) to further heat the vaporous ammonia, and (ii) lastly to provide the evaporation heat for evaporating the ammonia; or,
in the flow direction of the combustion gases, (0) first to heat the reformate gas, then (i) to provide the reaction heat for reforming the ammonia, (ii) additionally to further heat the vaporous ammonia, and (iii) lastly to provide the evaporation heat for evaporating the ammonia.

13. An apparatus for implementing the process according to claim 1, comprising:
optionally an apparatus for heating the methanol or ammonia;
an evaporation apparatus;
a reforming reactor,
a membrane apparatus;
at least one burner;
at least two heat exchangers; and,
means for introducing and/or discharging fluids on the evaporation apparatus, on the reforming reactor, on the membrane apparatus, on the burner or burners, on the heat exchangers, and optionally on the apparatus for heating the methanol or ammonia.

14. The apparatus according to claim 13, wherein the tube diameter of the heat exchangers is between 1 and 6 mm.
